(19) United States
(12) Patent Application Publication
(10) Pub. No.: US 2007/0064230 A1
(43) Pub. Date: Mar. 22, 2007

(54) Broadband laser spectroscopy

(75) Inventors: Warren W. Harper, Benton City, WA (US); Richard M. Williams, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/233,436

(22) Filed: Sep. 21, 2005

(51) Int. Cl. G01J 3/28

(52) U.S. Cl. 356/328

(57) ABSTRACT

Apparatus and processes for chemical sensing are disclosed. Embodiments of the present invention comprise a laser device producing a broadband spectral output that can interact with a sample, a wavelength dispersive element, and a detector. The width of the broadband spectral output is greater than or approximately equal to the width of a spectral feature of the sample. The wavelength dispersive element can resolve the broadband spectral output after the broadband spectral output has had an interaction with the sample. The detector detects the intensity of the wavelength-resolved broadband spectral output.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Many chemical sensing techniques utilize light sources that cover either a very broad range of wave numbers, or a very narrow range. For example, Fourier Transform Infrared techniques cover an extremely wide range of wave numbers (typically approximately 4000 cm⁻¹), while active laser techniques are typically narrow and might only cover 1 cm⁻¹ or less. However, it is generally preferable when a feature being probed is slightly narrower than the tuning range of the laser so that the entire feature can be scanned while concentrating the laser bandwidth on the feature. Since typical features, for example absorption features, are 10 to 50 cm⁻¹ wide, neither of the above-mentioned techniques is optimal. Accordingly, a need exists for a chemical sensing apparatus that can more effectively probe broad spectroscopic features.

### SUMMARY

One aspect of the present invention encompasses an apparatus for chemical sensing. The apparatus comprises a laser device producing a broadband spectral output that can interact with a sample, a wavelength dispersive element, and a detector. The width of the broadband spectral output is greater than or approximately equal to the width of a spectral feature of the sample. In some embodiments, the width of the broadband spectral output can be greater than or approximately equal to the width of a spectral feature and less than or approximately equal to twice the width of the spectral feature. In additional embodiments, the width of the broadband spectral output can be approximately equal to the width of a spectral feature of the sample. The wavelength dispersive element can resolve the broadband spectral output after the broadband spectral output has had an interaction with the sample. As used herein, interaction between the broadband spectral output and the sample can refer to transmission, absorption, and/or reflection. The detector detects the intensity of the wavelength-resolved broadband spectral output. The detector can comprise a single-element detector or it can comprise an array of single elements.

In a further embodiment, the laser device comprises a semiconductor laser. Examples of semiconductor lasers can include, but are not limited to Fabry-Perot quantum cascade lasers (FP-QCL), Fabry-Perot diode lasers, and lead-salt lasers.

In another embodiment, the width of the broadband spectral output can be less than or equal to approximately 200 wave numbers. More specifically, the width can range from approximately 10 to approximately 70 wave numbers. The center of the broadband spectral output can range from approximately 500 to approximately 10,000 wave numbers.

Examples of wavelength dispersive elements can include, but are not limited to gratings, Fourier-transform infrared spectrometers (FTIR), scanning etalons, variable thin-film filters, and prisms.

In yet another embodiment, at least a portion of the broadband spectral output is characterized prior to interacting with the sample. The portion of the broadband spectral output characterized prior to interacting with the sample can be used as a reference beam for intensity normalization.

In still another embodiment, the broadband spectral output is directed in a monostatic, bistatic, or perimeter configuration.

Another aspect of the present invention encompasses producing a broadband spectral output from a laser device, resolving the broadband spectral output after the broadband spectral output has interacted with a sample, and measuring the intensity of the wavelength-resolved broadband spectral output. The width of the broadband spectral output is greater than or approximately equal to the width of a spectral feature of a sample.

### DESCRIPTION OF DRAWINGS

Embodiments of the invention are described below with reference to the following accompanying drawings.

FIG. 1 is a schematic diagram of an embodiment of broadband laser spectroscopy.

FIG. 2 is a graph of the broadband spectral output from a FP-QCL device.

FIG. 3 is a schematic diagram of an embodiment of broadband laser spectroscopy.

FIG. 4 is a graph showing a dimethyl methylphosphonate spectral feature and the broadband spectral output from a FP-QCL device.

FIG. 5 is a schematic diagram showing various configurations.

### DETAILED DESCRIPTION

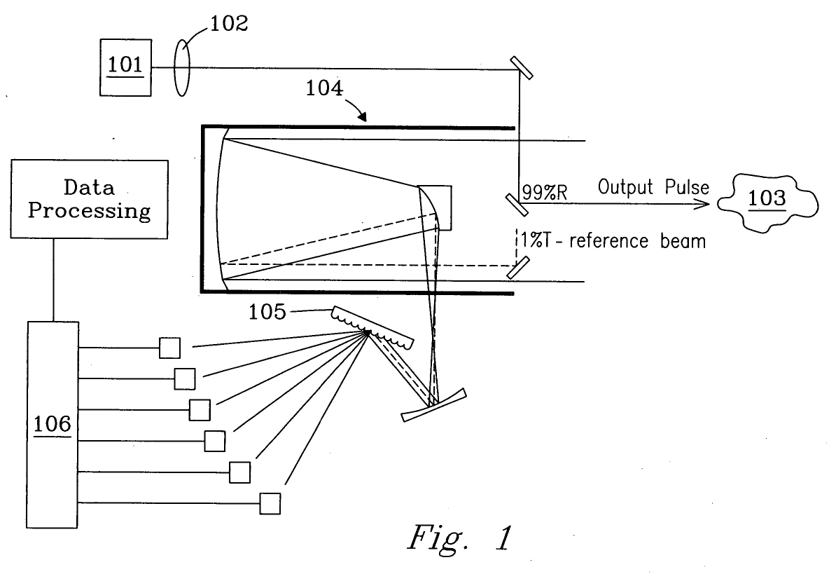

Referring to the embodiment shown in FIG. 1, a broadband laser 101 produces a broadband spectral output. The broadband spectral output can be collimated using collimation optics 102 and directed to a sample 103. The sample can be housed in a container or it can be an openpath sample through which the laser passes (i.e., remote sensing applications). The broadband spectral output can interact with the sample 103 and be directed to a wavelength dispersive element 105 by collection optics 104. An example of collection optics can include, but is not limited to telescopes. In the present embodiment the wavelength dispersive element is a grating. The wavelength-dispersed broadband spectral output is then detected by the detector array 106. The use of the grating 105 and the detector array allows a complete spectrum to be obtained with all wavelengths collected substantially simultaneously. Alternatively, a scanning monochrometer can be used for dispersing the broadband spectral output. The wavelengths can be quickly scanned over a feature of interest and a spectrum can be collected on a given timescale. Collection on a millisecond timescale can help mitigate atmospheric turbulence noise.

Excess intensity noise during remote chemical sensing can reduce the signal to noise ratio of the intensity measurements to unity (i.e., S/N=1), which can severely impact the sensitivity of absorption experiments. The noise can be imparted on a returning laser beam after traveling long distances (e.g., several kilometers) through a turbulent atmosphere. The noise can be caused by index of refraction variations in the atmosphere, which can cause the laser beam to break up and become inhomogeneous. The timescale of these variations is typically 1 to 10 milliseconds. Since all modes of the broadband laser device can be emitted simultaneously, all the modes experience common intensity noise, as long as the measurement time is less than 1 ms. Accordingly, there would be no substantial intensity fluctuation noise introduced in a single spectrum. In essence a noise free mini spectrum can be recorded every millisecond, or faster. Details regarding additional noise reduction techniques are described in U.S. Patent Application 2005-0099632A1, which details are incorporated herein by reference.

As used herein, broadband spectral output can refer to the multimode output of a laser device. Many applications utilize lasers operating in a single wavelength mode, where the wavelength is scanned in time. For example, many FP-QCL devices are made to operate at a single wavelength by adding a distributed feedback (DFB) grating. Addition of the DFB grating can significantly limit the tuning range of the laser device, often to approximately 1.5 cm⁻¹, thereby limiting the types of molecular spectral features that can be probed. FP-QCL devices without a DFB grating can emit light in many wavelengths over a wide range. This range is commonly between 20 and 40 cm⁻¹, but can vary according to optimization and fabrication techniques.

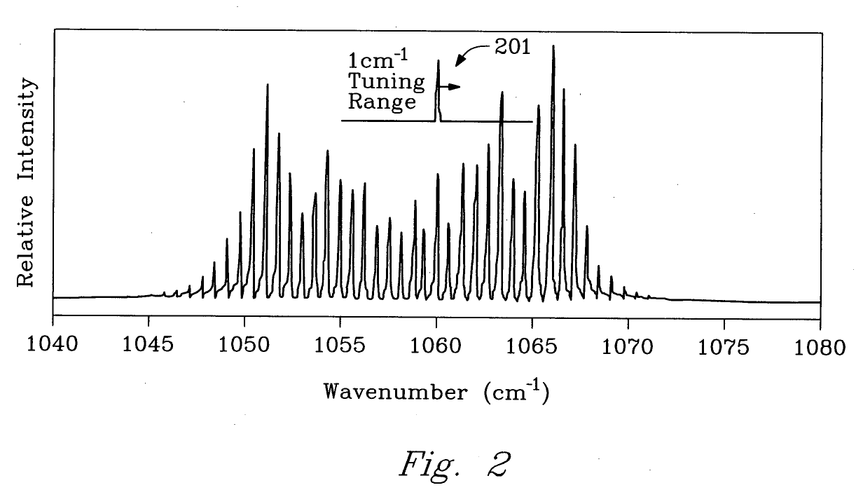

FIG. 2 is a graph of the broadband spectral output of a FP-QCL device without a DFB grating. The broadband spectral output includes over 30 emission peaks, or longitudinal modes, approximately equally spaced by about 0.6 cm⁻¹. The spectral coverage is roughly 20 cm⁻¹. Properties of the broadband spectral output, including but not limited to the spectral coverage and number of modes, can be tuned as is known in the art. Such tuning can result in spectral coverages that are even wider to probe wider spectral features. For purposes of comparison, the inset 201 shows the tuning range of a FP-QCL device having a DFB grating. Accordingly, the broadband spectral output can form a wavelength comb that is broader than the tuning range of a laser operating in a single wavelength mode.

In one embodiment, the wavelength comb of a FP-QCL can be fabricated to span an absorption feature of a chemical species of interest. Chemometric methods can be applied to quantify absorption and chemical concentration while providing chemical speciation.

### EXAMPLE

### Probing a Dimethyl Methylphosphonate (DMMP) Spectral Feature with a FP-QCL

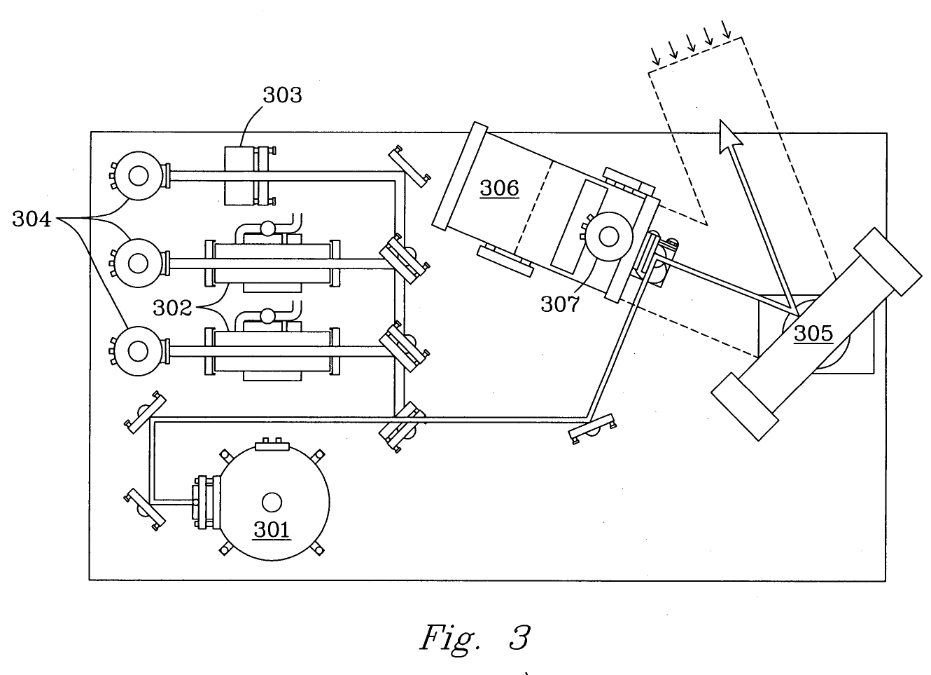

FIG. 3 shows a schematic diagram of the experiment setup. A QC laser 301 emits a broadband spectral output, which is split and directed along two different paths. A first path directs a portion of the output to diagnostics components. In the present example, the diagnostic components include reference gas cells 302, an etalon 303, and their associated detectors 304. The reference gas cells can be used to tune and calibrate the QC laser and detection hardware. In one embodiment, the reference gas cells can contain a reference sample of the chemical of interest.

A second path directs the remainder of the broadband spectral output to the sample via reflection from a gimbled mirror 305, which is positioned such that light scattered by the sample will return along substantially the same path traveled by the outbound broadband spectral output and be received by a telescope 306. The gimbled mirror allows the broadband spectral output to be spatially scanned through a volume while maintaining alignment with the receiver telescope 306 and detector 307.

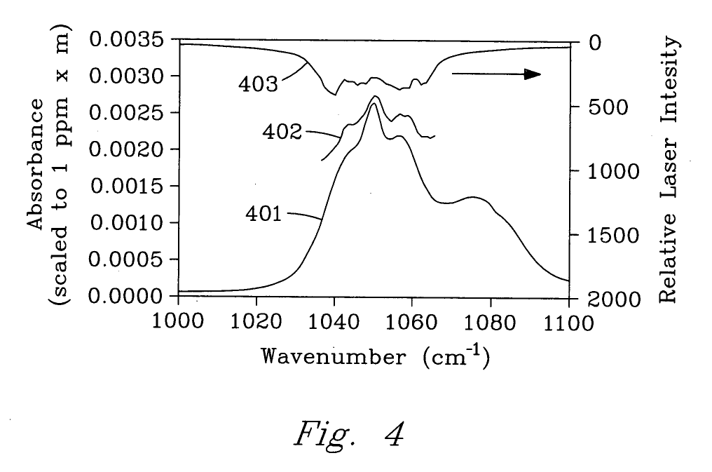

FIG. 4 is a graph of absorbance as a function of wavenumber having plotted thereon a reference spectrum of DMMP 401, an experimentally acquired spectrum of DMMP 402, and the broadband spectral output 403. While the results are not optimal, since the chosen DMMP feature is slightly broader than the broadband spectral output, the spectrum is still faithfully reproduced.

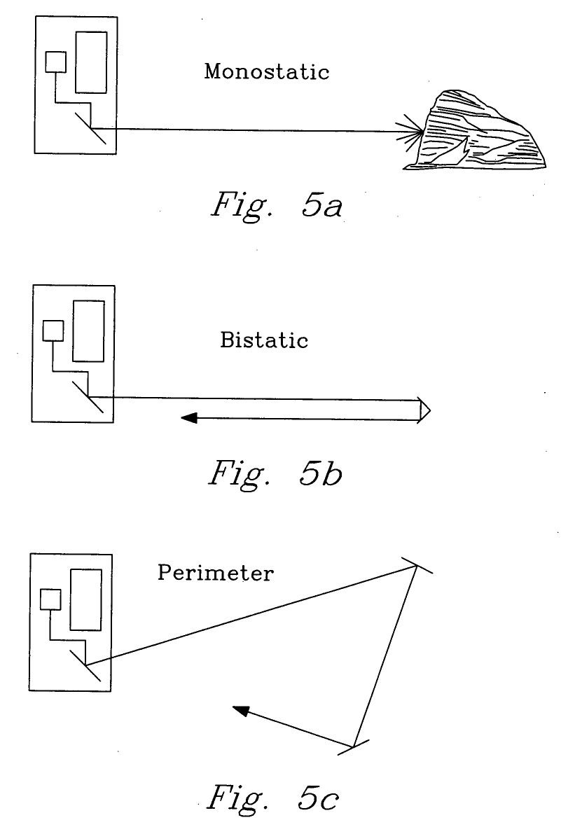

FIGS. 5(a)-(c) show schematic diagrams of various configurations encompassed by embodiments of the present invention. FIG. 5(a) shows a monostatic configuration, wherein an existing object can be utilized to scatter light back towards the detector. Examples of existing objects can include, but are not limited to buildings, rocks, and road signs. FIG. 5(b) shows a bistatic configuration wherein a mirror or other reflective object is placed in the field and is used to scatter light back towards the detector. FIG. 5(c) shows a perimeter configuration wherein a plurality of reflective objects is used to direct the laser in a volume of space. The perimeter configuration can be applied to monitor the perimeter surrounding an area of interest. Thus, if a chemical is detected and breaches the perimeter, appropriate action can be taken.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An apparatus for chemical sensing comprising:
a. a laser device producing a broadband spectral output, wherein the width of the broadband spectral output is greater than or approximately equal to the width of a spectral feature of a sample;
b. a wavelength dispersive element to resolve the broadband spectral output after the broadband spectral output has had an interaction with the sample; and
c. a detector to measure the intensity of the wavelength-resolved broadband spectral output.

2. The apparatus as recited in claim 1, wherein the interaction is transmission, absorption, reflection, or combinations thereof.

3. The apparatus as recited in claim 1, wherein the width of the broadband spectral output is less than or approximately equal to twice the width of the spectral feature of the sample.

4. The apparatus as recited in claim 1, wherein the width of the broadband spectral output is less than or equal to approximately 200 wave numbers.

5. The apparatus as recited in claim 1, wherein the width of the broadband spectral output ranges from approximately 10 to approximately 70 wave numbers.

6. The apparatus as recited in claim 1, wherein the center of the broadband spectral output ranges from approximately 500 to approximately 10,000 wave numbers.

7. The apparatus as recited in claim 1, wherein the laser device is a semiconductor laser.

8. The apparatus as recited in claim 7, wherein the semiconductor laser is a Fabry-Perot quantum cascade laser, a Fabry-Perot diode laser, or a lead-salt laser.

9. The apparatus as recited in claim 1, wherein the wavelength dispersive element comprises a device selected from the group consisting of gratings, Fourier-transform infrared spectrometers, scanning etalons, variable thin-film filters, prisms, and combinations thereof.

10. The apparatus as recited in claim 1, wherein the detector comprises a single-element.

11. The apparatus as recited in claim 1, wherein the detector comprises an array of single-elements.

12. The apparatus as recited in claim 1, wherein at least a portion of the broadband spectral output is characterized prior to interaction with the sample.

13. The apparatus as recited in claim 1, wherein the broadband spectral output is directed in a monostatic, bistatic, or perimeter configuration.

14. An apparatus for chemical sensing comprising:
a. a Fabry-Perot quantum cascade laser producing a broadband spectral output, wherein the width of the broadband spectral output is approximately equal to the width of a spectral feature of a sample;
b. a wavelength dispersive element to resolve the broadband spectral output after the broadband spectral output has had an interaction with the sample; and
c. a detector to measure the intensity of the wavelength-resolved broadband spectral output.

15. A process for sensing chemicals comprising
producing a broadband spectral output from a laser device, wherein the width of the broadband spectral output is greater than or approximately equal to the width of a spectral feature of a sample;
resolving the broadband spectral output after the broadband spectral output has interacted with the sample;
measuring the intensity of the wavelength-resolved broadband spectral output.

16. The process as recited in claim 15, wherein the broadband spectral output is less than or approximately equal to twice the width of the spectral feature.

17. The process as recited in claim 15, wherein the laser device is a semiconductor laser.

18. The process as recited in claim 17, wherein the semiconductor laser is a Fabry-Perot quantum cascade laser, a Fabry-Perot diode laser, or a lead-salt laser.
